(19) United States
(12) Patent Application Publication
(10) Pub. No.: US 2025/0336135 A1
(43) Pub. Date: Oct. 30, 2025

(54) SYSTEM AND METHOD FOR PROVIDING AN INTERACTIVE VIRTUAL CLASSMATE TO PROMOTE STUDENT PARTICIPATION IN A VIRTUAL REALITY CLASSROOM

(71) Applicant: Purdue Research Foundation, West Lafayette, IN (US)

(72) Inventors: Karthik Ramani, West Lafayette, IN (US); Zhengzhe Zhu, West Lafayette, IN (US); Ziyi Liu, Delaware, OH (US)

(21) Appl. No.: 19/183,412

(22) Filed: Apr. 18, 2025

Related U.S. Application Data
(60) Provisional application No. 63/637,549, filed on Apr. 23, 2024.

(51) Int. Cl. G06T 13/40; G06F 40/40; G06T 13/20; G09B 7/02

(52) U.S. Cl. CPC G06T 13/40; G06F 40/40; G06T 13/205; G09B 7/02

(57) ABSTRACT

A virtual learning system is introduced herein that provides a virtual reality classroom environment having a virtual agent. The virtual agent plays the role of an active student and promotes classroom participation through verbal and nonverbal interactions with the teacher and other students. The virtual agent, which is embodied as a 3D virtual avatar in virtual reality, interacts with an actual teacher and actual students with both spoken language and body gestures. The behaviors of the virtual agent avatar help to encourage other students to participate more actively in the virtual classroom environment.

This application claims the benefit of priority of U.S. provisional application Ser. No. 63/637,549, filed on Apr. 23, 2024 the disclosure of which is herein incorporated by reference in its entirety.

### GOVERNMENT LICENSE RIGHTS

This invention was made with government support under DUE1839971 awarded by the National Science Foundation. The government has certain rights in the invention.

### FIELD

The devices and methods disclosed in this document relate to virtual reality and, more particularly, to providing an interactive virtual classmate in a virtual reality classroom.

### BACKGROUND

Unless otherwise indicated herein, the materials described in this section are not admitted to be the prior art by inclusion in this section.

The contemporary view on education emphasizes the importance of active participation of the student in the classroom to facilitate effective knowledge acquisition. Instead of being passive recipients of knowledge from the teachers, students are encouraged to actively participate in their learning process through continuous interactions with the teachers and their peers. The presence of such classroom dynamics has been indicated to be highly correlated with the academic success of the students. Generally, the responsibility for ensuring student engagement in the learning process lies with the teacher, which could be a challenge considering their limited attention. On the other side of the spectrum, researchers have observed that conducive peer influence can supplement teachers' efforts to promote classroom participation. For instance, the practice of individual students asking and answering questions can help establish a social norm in the classroom that encourages such behavior, creating opportunities for further inquiry from others. Individual students can also play an important role in driving the classroom discussion and dissuading others from engaging in disruptive behaviors (e.g., off-topic conversations). In addition, their self-behaviors, like note-taking, would subtly prompt others to follow them. Students who demonstrate the behaviors mentioned above are typically identified as active students. While active students contribute significantly to the dynamics of the classroom, their active participation in a classroom depends on many factors and, therefore, is not guaranteed.

Peer influence plays a crucial role in promoting classroom participation, where behaviors from active students can contribute to a collective classroom learning experience. However, the presence of these active students depends on several conditions and is not consistently available across all circumstances. What is needed is a learning system for reliably promoting such active classroom behavior.

### SUMMARY

A method for providing a virtual agent for a virtual classroom environment is disclosed herein. The method comprises hosting with at least one server, or connecting to a further server that hosts, the virtual classroom environment in which a plurality of users each connect to the virtual classroom environment with a respective virtual reality device and control respective first virtual avatars within the virtual classroom environment using the respective virtual reality device. The method further comprises receiving, with the at least one server, speech of the plurality of users as the plurality of users interact with one another in the virtual classroom environment. The method further comprises providing, with the at least one server, the speech to a language model. The method further comprises receiving, with the at least one server, a response from the language model that is responsive to the speech. The method further comprises controlling, with the at least one server, a second virtual avatar within the virtual classroom environment based on the response.

Another method for providing a virtual agent for a virtual classroom environment is also disclosed herein. The method comprises providing, with a virtual reality device, the virtual classroom environment in which a user can control a first virtual avatar within the virtual classroom environment using the respective virtual reality device; receiving speech of the user. The method further comprises providing the speech to a language model. The method further comprises receiving a response from the language model that is responsive to the speech. The method further comprises controlling a second virtual avatar within the virtual classroom environment based on the response.

### BRIEF DESCRIPTION OF THE DRAWINGS

The foregoing aspects and other features of the system and method are explained in the following description, taken in connection with the accompanying drawings.

FIG. 1 shows an exemplary virtual classroom environment enabled by the virtual learning system.

FIG. 2A shows exemplary behaviors of a virtual agent interacting with a teacher.

FIG. 2B shows exemplary behaviors of a virtual agent interacting with students.

FIG. 2C shows exemplary self-behaviors of a virtual agent.

FIG. 3A shows an exemplary embodiment of the virtual learning system.

FIG. 3B shows exemplary components of a virtual reality system of the virtual learning system.

FIG. 4 shows a logical flow diagram for a method for providing a virtual agent for a virtual classroom environment.

FIG. 5 shows an exemplary tuning prompt for prompting the language model.

FIG. 6 shows a variety of exemplary prompts paired with responses from the large language model.

FIG. 7 shows exemplary behaviors of the virtual agent avatar(s) within the virtual classroom environment.

FIG. 8 shows a user physically taking notes while wearing the VR-HMD.

FIG. 9 shows a variety of exemplary additional application scenarios utilizing virtual agents in a virtual classroom environment.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### System Overview

A virtual learning system 300 is introduced herein that provides a virtual classroom environment having a virtual agent, which plays the role of an active student and promotes classroom participation through verbal and nonverbal interactions with the teacher and other students. The virtual agent, which is embodied as a 3D virtual avatar in virtual reality, interacts with an actual teacher and actual students with both spoken language and body gestures.

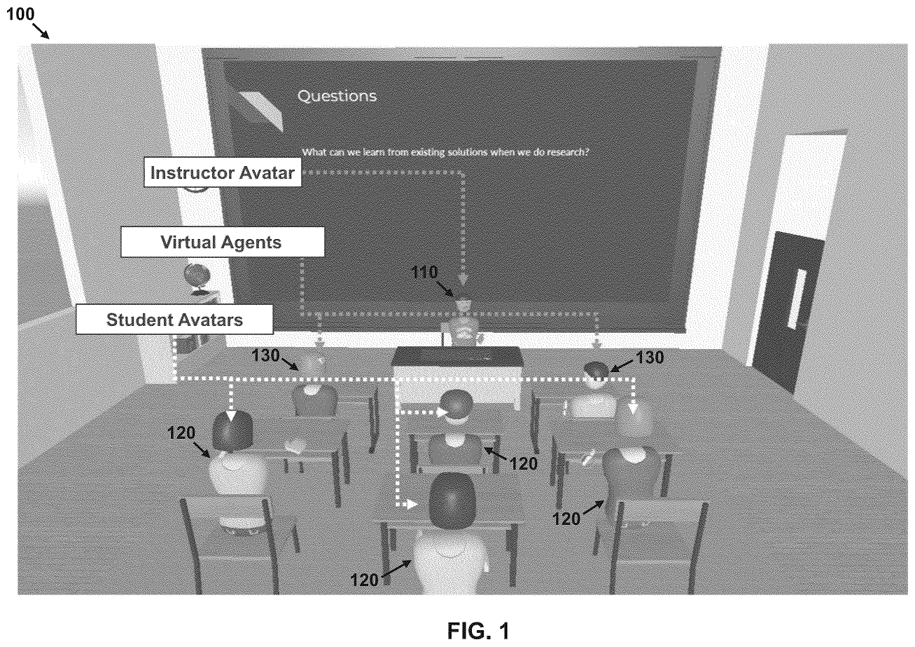

FIG. 1 shows an exemplary virtual classroom environment 100 enabled by the virtual learning system 300. Students and teachers can connect to and interact with the virtual classroom environment 100 using virtual reality systems 350. The virtual classroom environment 100 emulates the layout of a real classroom, includes student desks, a teacher's podium, and a virtual blackboard. Within the virtual classroom environment 100, each student or teacher embodies a respective 3D virtual avatar. In the illustrated example, the virtual classroom environment 100 includes one teacher avatar 110 standing in front of the virtual classroom environment 100 and four student avatars 120 sitting at desks within the virtual classroom environment 100. Within the virtual classroom environment 100, the teacher can provide instruction to the students, e.g., by way of a lecture that is optionally supported by visual aids shown on the virtual blackboard 140 within the virtual classroom environment 100. In this manner, the virtual classroom environment 100 simulates a typical in-person classroom environment. However, unlike a typical in-person classroom environment, the virtual classroom environment 100 further includes one or more virtual agents that embody virtual avatars that are essentially similar to those embodied by the students. In the illustrated example, the virtual classroom environment 100 includes two virtual agent avatars 130.

Through both body language and spoken language, the virtual agent avatars 130 are designed to behave in a manner that emulates an active student. To these ends, the virtual learning system 300 leverages a state-of-the-art large language model to absorb the real-time context of the virtual classroom environment 100 and control the virtual agent avatars 130 to actively participate in the classroom. Particularly, before a class session, the virtual learning system 300 provides a set of lecture notes and the highlighted key points to the large language model as background context. During the class, the virtual learning system 300 records the conversations between the teacher and the students and provides the conversations to the large language model as real-time context. With the provided contextual information, the virtual learning system 300 prompts the large language model to provide responses that dictate the behavior of the virtual agent avatars 130 within the virtual classroom environment 100. With the real-time classroom context, the responses from the large language model allow the virtual learning system 300 to adapt the behavior of the virtual agent avatars 130 to stay in sync with the evolving dynamics of the class. Through their behaviors, the virtual agent avatars 130 subtly cultivate a positive behavioral norm in the classroom through verbal and nonverbal interactions with the teacher and other students.

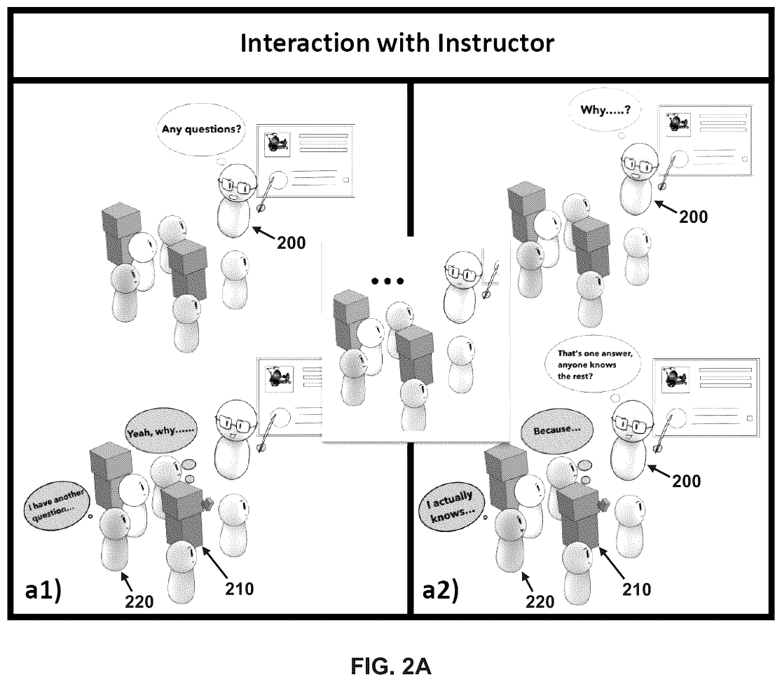

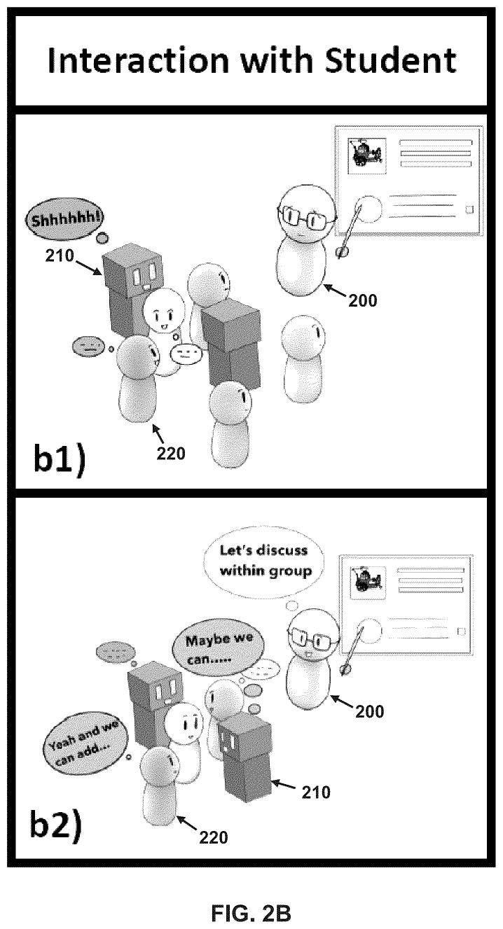

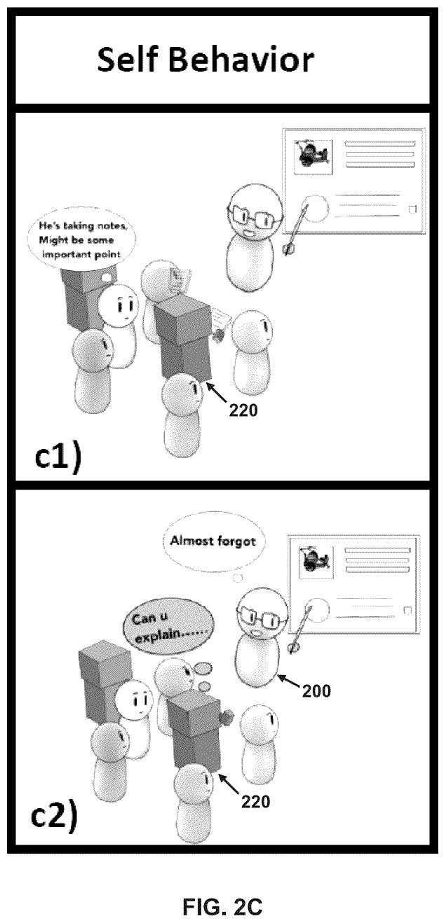

FIGS. 2A-2C summarize how the virtual agent(s) interact with the students and teacher within the virtual classroom environment 100 to promote classroom participation. The different classroom participation-promoting behaviors generated by the virtual agent(s) can be split into three categories: (1) Interactions with a Teacher, (2) Interactions with a Student, and (3) Self-Behaviors.

FIG. 2A shows exemplary behaviors of a virtual agent interacting with a teacher. In the example of illustration al), the teacher 200 asks the students 210 whether they have any questions. Similarly, in the example of illustration a2), the teacher 200 asks the students 210 to answer a question. Encouraging students to ask and to answer questions is a common way for teachers to engage students in the classroom. However, speaking up in front of the whole class could be intimidating, which makes the students 210 reluctant to ask questions themselves or react to questions from the teacher 200. If it happens to every student 210, the whole class will fall into complete silence.

In this circumstance, the virtual agent 220 plays the role of an active student who can break the ice. When the virtual agent 220 detects that the class has been silent for a certain amount of time, it will intervene by either raising a question or answering the question according to the context. In the example of illustration a1), the virtual agent 220 will pose relevant questions based on its contextual knowledge of the lecture topic and the current query from the teacher 200. In the example of illustration a2), when answering the question, the virtual agent 220 will intentionally answer only a part of the question, thereby giving the students 210 the opportunity to complete the answer and increasing their participation. As a result of the virtual agent 220 breaking the silence, one of the students 210 may be encouraged to provide a follow-up question or a follow-up answer of their own.

FIG. 2B shows exemplary behaviors of a virtual agent interacting with students. In the example of illustration b1), as the class progresses, some students 210 may inevitably become distracted and engage in off-topic discussions with their classmates. This is often seen as disruptive behavior that negatively affects the entire class. By comparing captured student conversations to the lecture topic, the virtual agent 220 identifies and intervenes to reduce the off-topic conversations. In particular, the virtual agent 220 turns to the distracted students and issues verbal and non-verbal reminders (e.g., “Shhhhhh!”)

In the example of illustration b2), a group discussion session in a classroom may experience a state of stagnation if the students 210 exhibit hesitancy in articulating their opinions or if they exhaust their new ideas. At this time, the virtual agent 220 breaks the ice by bringing a fresh viewpoint to propel the discussion forward (e.g., “Maybe we can . . . ”). As a result of the virtual agent 220 breaking the silence, another students 210 may be encouraged to continue the discussion.

FIG. 2C shows exemplary self-behaviors of a virtual agent. The virtual agent 220 reproduces the self-behavior of an active student, which is also a key factor in influencing the quality of a class. In the example of illustration c1), virtual agent 220 acts like it is taking notes when the teacher 200 goes through the key points of the lecture. In the example of illustration c2), when the teacher 200 fails to explain a concept clearly, the virtual agent 220 raises a question about that concept, which allows the teacher 200 to explain the concept with more detail. In contrast to the example of illustration al) in FIG. 2A in which the virtual agent 220 asks questions in response to the teacher's express query, in the example of illustration c2) of FIG. 2C, the virtual agent 220 proactively initiates this question-asking behavior, which assists teachers in addressing any unintentional oversight (e.g., missing a key point of their lecture).

### Exemplary Hardware Embodiment

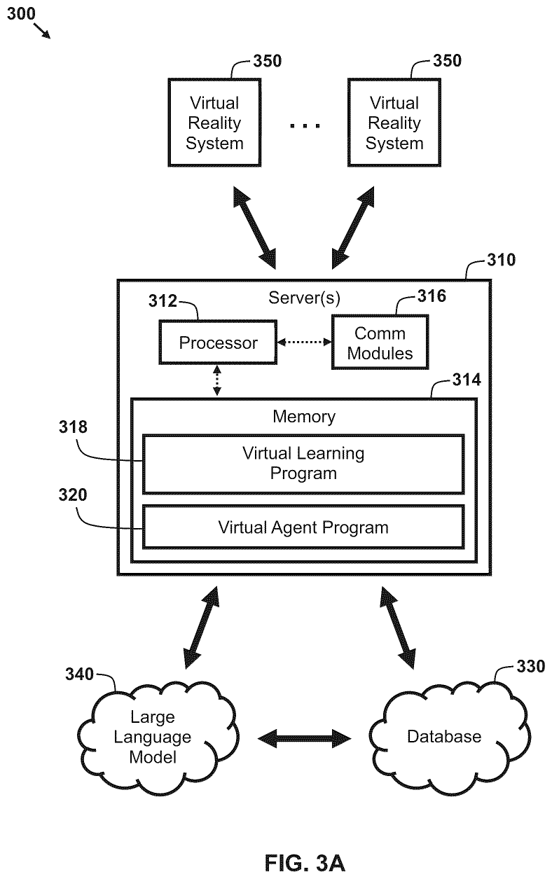

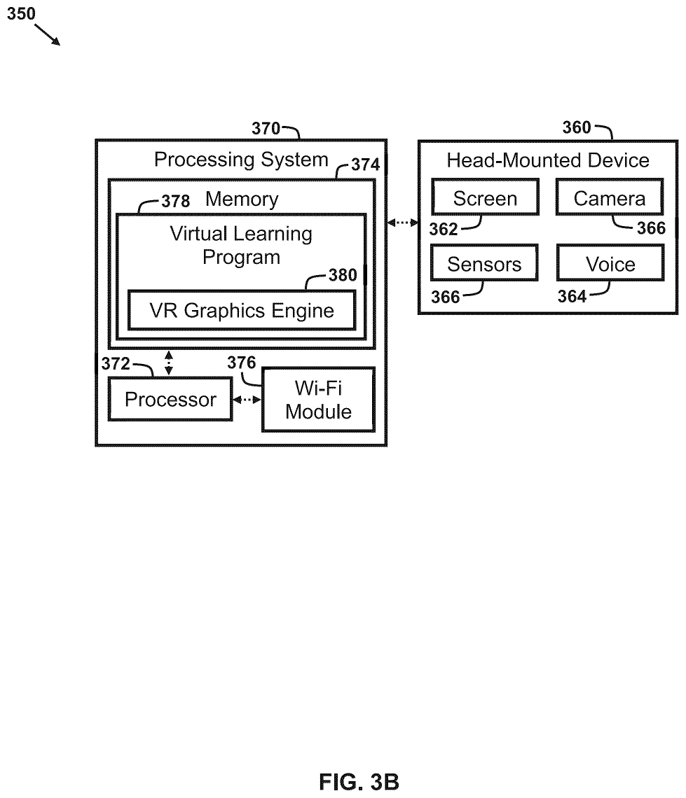

FIG. 3A shows an exemplary embodiment of the virtual learning system 300. In the illustrated embodiment, the virtual learning system 300 includes one or more server(s) 310 and a plurality of virtual reality systems 350. At least one of the server(s) 310 hosts a virtual classroom learning session that enables a plurality of users of the plurality of virtual reality systems 350 to virtually interact with one another in a virtual classroom environment. The virtual classroom learning session enables real-time audio-based voice communications between users and enables each user to embody a virtual avatar within the virtual classroom environment, in a manner that is essentially similar to an online multiplayer video game. In some embodiments, at least one of the server(s) 310 stores context data regarding the voice communications of the users in a database 330. In addition to hosting the virtual classroom learning session, at least one of the server(s) 310 also implements one or more virtual agents that embody virtual avatars with the virtual classroom environment and which are controlled at least in part using responses received from a large language model 340 and using the context data stored in the database 330. Each virtual reality system 350 is configured to enable a user to connect to the server(s) 310 to participate in a virtual classroom learning session, including audio-based voice communications and control of a respective virtual avatar within the virtual classroom environment.

The server(s) 310 may include one or more servers configured to serve a variety of functions for the virtual learning system 300, including web servers or application servers, depending on the features provided by the virtual learning system 300. For example, in some embodiments, the server 310 that hosts the virtual classroom learning session may be different from the server 310 that implements one or more virtual agents. Additionally, it should also be appreciated that the server(s) 310 may include or be one of the virtual reality systems 350. For example, in some embodiments, rather than centrally hosting the virtual classroom learning session at a dedicated server, one of the virtual reality systems 350 can host the virtual classroom learning session in a peer-to-peer manner that enables the other virtual reality systems 350 to connect to the session without the need for a dedicated server.

Each server 310 includes, for example, a processor 312, a memory 314, and a network communications module 316. It will be appreciated that the illustrated embodiment of the server(s) 310 is only one exemplary embodiment of a server 310 and is merely representative of any of various manners or configurations of a personal computer, server, or any other data processing system that is operative in the manner set forth herein.

The processor 312 is configured to execute instructions to operate the server(s) 310 to enable the features, functionality, characteristics, and/or the like as described herein. To this end, the processor 312 is operably connected to the memory 314 and the network communications module 316. The processor 312 generally comprises one or more processors, which may operate in parallel or otherwise in concert with one another. It will be recognized by those of ordinary skill in the art that a “processor” includes any hardware system, hardware mechanism, or hardware component that processes data, signals, or other information. Accordingly, the processor 312 may include a system with a central processing unit, graphics processing units, multiple processing units, dedicated circuitry for achieving functionality, programmable logic, or other processing systems.

The memory 314 is configured to store program instructions that, when executed by the processor 312, enable the server(s) 310 to perform various operations described herein. The memory 314 may be any type of device or combination of devices capable of storing information accessible by the processor 312, such as memory cards, ROM, RAM, hard drives, discs, flash memory, or any of various other computer-readable media recognized by those of ordinary skill in the art. The memory 314 stores one or both of a virtual learning program 318 and a virtual agent program 320. The processor 312 executes program instructions of the virtual learning program 318 to host the virtual classroom learning session and enable the users of the plurality of virtual reality systems 350 to interact virtually with one another in the virtual classroom environment. Additionally, the processor 312 executes program instructions of the virtual agent program 320 to implement the virtual agents that embody virtual avatars within the virtual classroom environment and control the virtual agents using responses received from the large language model 340.

The network communications module 316 may comprise one or more transceivers, modems, processors, memories, oscillators, antennas, or other hardware conventionally included in a communications module to enable communications with various other devices, at least including the virtual reality systems 350. In particular, the network communications module 316 may include a local area network port that allows for communication with any of various local computers housed in the same or nearby facility. Generally, the server(s) 310 communicate with remote computers over the Internet via a separate modem and/or router of the local area network. Alternatively, the network communications module 316 may further include a wide area network port that allows for communications over the Internet. In one embodiment, the network communications module 316 is equipped with a Wi-Fi transceiver or other wireless communications device. Accordingly, it will be appreciated that communications with the server(s) 310 may occur via wired communications or via wireless communications. Communications may be accomplished using any of various known communication protocols.

With continued reference to FIG. 3A, the large language model 340 is a machine learning-based model, for example in the form of an artificial neural network. The language model is configured to receive natural language text as an input prompt and generate natural language text as an output response. In at least some embodiments, the language model is a large language model 340, such as OpenAI's ChatGPT™, Google's Gemini™, or Anthropic's Claude™. A large language model 340 is a generative machine learning model that is trained on vast amounts of textual data to understand and generate human-like responses to natural language prompts. These models are designed to predict and produce coherent and contextually relevant text, imitating human language fluency. They work by analyzing patterns in language data, learning grammar, context, and meaning, and then using that knowledge to generate new content.

In general, the large language model 340 is implemented by a remote third-party server rather than being operated directly by the server(s) 310. Instead, the server(s) 310 interface with the large language model 340 via Internet communications using an API. Particularly, once a natural language prompt is finalized, the processor 312 operates the network communications module 316 to transmit a message, including the natural language prompt, to a server hosting the large language model 340. In response, the processor 312 receives via the network communications module 316 a natural language response from the large language model 340 that includes text that is responsive to the natural language prompt. However, in alternative embodiments, one of the server(s) 310 may store the large language model 340 and execute the large language model 340 to generate the natural language response locally.

FIG. 3B shows exemplary components of a virtual reality system 350 of the virtual learning system 300. The virtual reality systems 350 at least includes a virtual reality head-mounted device (VR-HMD) 360, least part of which is worn or held by a user. In one example, the VR-HMD 360 is in the form of a virtual reality headset (e.g., Oculus Rift or Meta Quest) or equivalent VR glasses. However, it should be appreciated that, in alternative embodiments, the virtual reality system 350 may equivalently take the form of an augmented reality system. Thus, the system 350 may include an augmented reality headset or any other mobile device having at least a camera and a display screen, such as, but not limited to, a smartphone, a tablet computer, a handheld camera, or the like having a display screen and a camera. Likewise, it should be appreciated that any VR graphical user interfaces described herein might equivalently be provided in the form of AR graphical user interfaces.

Additionally, the virtual reality system 350 includes a processing system 370. In some embodiments, the processing system 370 may comprise a discrete computer that is configured to communicate with the VR-HMD 360 via one or more wired or wireless connections. In some embodiments, the processing system 370 takes the form of a backpack computer connected to the VR-HMD 360. However, in alternative embodiments, the processing system 370 is integrated with the VR-HMD 360. Moreover, the processing system 370 may incorporate server-side cloud processing systems. It should be appreciated that the components of the virtual reality system 350 shown and described are merely exemplary and that the virtual reality system 350 may comprise any alternative configuration.

With continued reference to FIG. 3B, the processing system 370 comprises a processor 372 and a memory 374. The memory 374 is configured to store data and program instructions that, when executed by the processor 372, enable the virtual reality system 350 to perform various operations described herein. The memory 374 may be of any type of device capable of storing information accessible by the processor 372, such as a memory card, ROM, RAM, hard drives, discs, flash memory, or any of various other computer-readable media serving as data storage devices, as will be recognized by those of ordinary skill in the art. Additionally, it will be recognized by those of ordinary skill in the art that a “processor” includes any hardware system, hardware mechanism, or hardware component that processes data, signals, or other information. The processor 372 may include a system with a central processing unit, graphics processing units, multiple processing units, dedicated circuitry for achieving functionality, programmable logic, or other processing systems.

The processing system 370 further comprises one or more transceivers, modems, or other communication devices configured to enable communications with various other devices. Particularly, in the illustrated embodiment, the processing system 370 comprises a Wi-Fi module 376. The Wi-Fi module 376 is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. As discussed in further detail below, the processor 372 is configured to operate the Wi-Fi module 376 to send and receive messages, such as control and data messages, to and from other devices via the Wi-Fi network and/or Wi-Fi router. It will be appreciated, however, that other communication technologies, such as Bluetooth, Z-Wave, Zigbee, or any other radio frequency-based communication technology, can be used to enable data communications between devices in the system.

In the illustrated exemplary embodiment, the VR-HMD 360 comprises a display screen 362, a voice communication interface 364, a variety of sensors 366, and a camera 368. The display screen 362 may comprise any of various known types of displays, such as LCD or OLED screens. In some embodiments, the voice communication interface 364 includes a microphone and a speaker. The microphone is configured to record sounds in the local environment of the user, at least including the speech of the user who wears the VR-HMD 360. The speaker is configured to output sounds, at least including the speech of other users connected to the virtual classroom learning session.

In some embodiments, the sensors 366 include sensors configured to measure one or more accelerations and/or rotational rates of the VR-HMD 360. In one embodiment, the sensors 366 include one or more accelerometers configured to measure linear accelerations of the VR-HMD 360 along one or more axes (e.g., roll, pitch, and yaw axes) and/or one or more gyroscopes configured to measure rotational rates of the VR-HMD 360 along one or more axes (e.g., roll, pitch, and yaw axes). In some embodiments, the sensors 366 may further include IR cameras. In some embodiments, the sensors 366 may include inside-out motion tracking sensors configured to track the human body motion of the user within the environment, in particular positions and movements of the head, arms, and hands of the user.

The camera 368 is configured to capture a plurality of images of the environment as the VR-HMD 360 is moved through the environment by the user. The camera 368 is configured to generate image frames of the environment, each of which comprises a two-dimensional array of pixels. Each pixel at least has corresponding photometric information (intensity, color, and/or brightness). In some embodiments, the camera 368 operates to generate RGB-D images in which each pixel has corresponding photometric information and geometric information (depth and/or distance) or, alternatively, separate RGB color images and depth images. In such embodiments, the camera 368 may, for example, take the form of an RGB camera that operates in association with a LIDAR camera to provide both photometric information and geometric information. Alternatively, or in addition, the camera 368 may comprise two RGB cameras configured to capture stereoscopic images, from which depth and/or distance information can be derived.

The VR-HMD 360 may also include a battery or other power source (not shown) configured to power the various components within the VR-HMD 360, which may include the processing system 370, as mentioned above. In one embodiment, the battery of the VR-HMD 360 is a rechargeable battery configured to be charged when the VR-HMD 360 is connected to a battery charger configured for use with the VR-HMD 360.

The program instructions stored in the memory 374 include a virtual learning program 378. As discussed in further detail below, the processor 372 is configured to execute the virtual learning program 378 to enable the virtual reality system 350 to connect to the virtual classroom learning session hosted by the server(s) 310 and enable the user of the virtual reality system 350 to virtually interact with other users within the virtual classroom environment. In one embodiment, the virtual learning program 378 includes a VR graphics engine 380 (e.g., Unity3D engine), which enables an immersive graphic representation of the virtual classroom environment and provides an intuitive visual interface for the virtual learning program 378.

### Methods for Providing a Virtual Classroom Environment with Virtual Agents

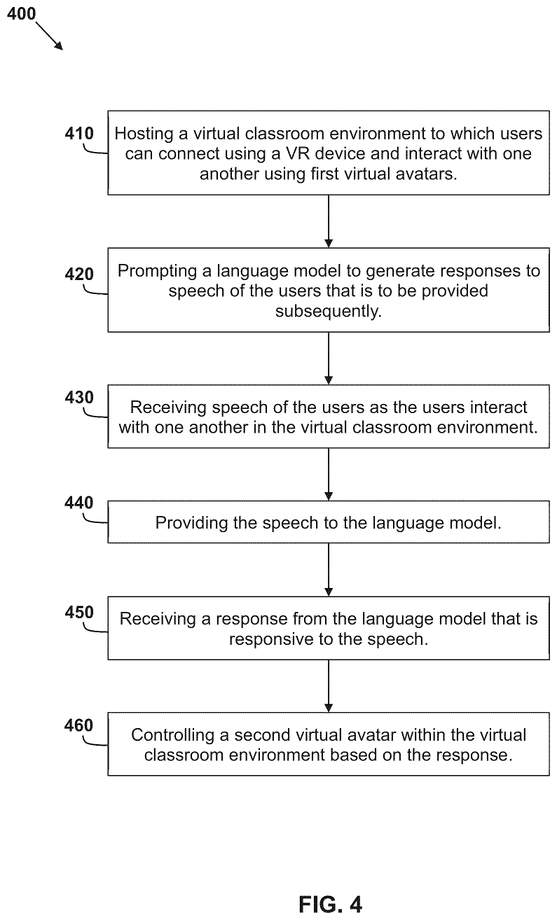

FIG. 4 shows a logical flow diagram for a method 400 for providing a virtual agent for a virtual classroom environment. The method 400 advantageously provides a virtual agent avatar, which plays the role of an active student and promotes classroom participation through verbal and nonverbal interactions with the teacher and other students. The behaviors of the virtual agent avatar help to encourage other students to participate more actively in the virtual classroom environment.

The method 400 begins with hosting a virtual classroom environment to which users can connect using a VR device and interact with one another using first virtual avatars (block 410). Particularly, the processor 312 of one of the server(s) 310 is configured to host, or connect to another server that hosts, a virtual classroom learning session and enable the users of a plurality of virtual reality systems 350 to connect and virtually interact with one another in a virtual classroom environment, including controlling virtual avatars within the virtual classroom environment and speaking with one another. As mentioned previously, it should also be appreciated that the server(s) 310 may include or be one of the virtual reality systems 350. For example, in some embodiments, one of the virtual reality systems 350 can host the virtual classroom learning session in a peer-to-peer manner that enables the other virtual reality systems 350 to connect to the session without the need for a dedicated server. Alternatively, the server(s) 310 can operate as a dedicated server that centrally hosts the virtual classroom learning session and which is distinct from the virtual reality systems 350.

At least one of the server(s) 310 operates as the central hub that hosts the virtual classroom learning session. The server 310 manages the authoritative simulation state of the virtual classroom environment, ensuring that each user's actions and avatar states are synchronized and processed accurately in real-time. The server(s) 310 receives and processes inputs from each virtual reality system 350, such as movements, interactions with objects, and gestures, and updates the simulation state accordingly. The server 310 then broadcasts these updates to each of the virtual reality systems 350 that are connected to the session to maintain a consistent experience for every participant, whether they are a teacher or a student. In some embodiments, the server 310 may leverage a third-party SDK, such as Photon Unity Networking, for multiplayer state management.

In addition to managing the simulated state of the virtual classroom environment, the server 310 also handles real-time voice communication between users. The server 310 utilizes a communication server or communication protocol, such as Photon Voice provided within the Photon Unity Networking SDK, to facilitate low-latency voice communications between users that are connected to the virtual classroom learning session.

When each virtual reality system 350 connects to the virtual classroom learning session, it first establishes a network connection to the server(s) 310 (e.g., over the Internet). Upon joining the session, the virtual reality system 350 communicates with the server(s) 310 to receive any assets (e.g., 3D models, textures, etc.) that are not already stored by the virtual reality system 350 and synchronizes the simulation states. Each virtual reality system 350 renders the virtual classroom environment and displays it to the user via the display screen 362 of the VR-HMD 360. Particularly, using the VR graphics engine 380, the virtual reality system 350 renders 3D models, textures, lighting, and animations within the virtual classroom environment. An exemplary virtual classroom environment is depicted in FIG. 1, which includes a teacher avatar 110 and student avatars 120, which are controlled by users of the virtual reality systems 350.

The rendering of the virtual classroom environment is, in part, based on the positions and orientations of the user's VR-HMD 360, which are tracked in real-time. The virtual reality system 350 sends this tracking data to the server(s) 310 to synchronize the user's virtual avatar with others in the virtual classroom environment. Each virtual avatar in the virtual classroom environment is represented as a 3D model and is animated to mirror the user's movements, such as head orientation and hand positions. To these ends, the virtual reality systems 350 are configured to continuously provide updated position and orientation states to the server(s) 310.

For the purpose of voice communication, the voice communication interface 364 of the virtual reality system 350 captures the user's speech input in real time via the microphone. The virtual reality system 350 transmits the audio data to the server(s) 310 and/or to each other virtual reality system 350 connected to the session. Likewise, the virtual reality system 350 receives recorded audio of other users' speech and outputs it using the microphone of the voice communication interface 364.

As will be discussed in greater detail below, in the embodiments described herein, in addition to hosting the virtual classroom learning session, at least one of the server(s) 310 also hosts the virtual agent that embodies the virtual agent avatar(s) within the virtual classroom environment. However, in practice, it should be appreciated that the server(s) 310 may include multiple servers, and the particular server 310 that hosts the virtual classroom learning session may be different from the server 310 that implements one or more virtual agents. Moreover, as similarly discussed above, the server that hosts the virtual agents may itself be one of the virtual reality systems 350.

The method 400 continues with prompting a language model to generate responses to speech of the users that is to be provided subsequently (block 420). Particularly, to enable the virtual agent that embodies the virtual agent avatar(s) within the virtual classroom environment, the processor 312 of one of the server(s) 310 is configured to, prior to or at the start of the virtual classroom learning session, provide a tuning prompt to the large language model 340 that tunes the behavior of the virtual agent. This tuning prompt includes natural language text instructing the large language model 340 how to generate responses to speech of the plurality of users that is to be subsequently provided during the virtual classroom learning session.

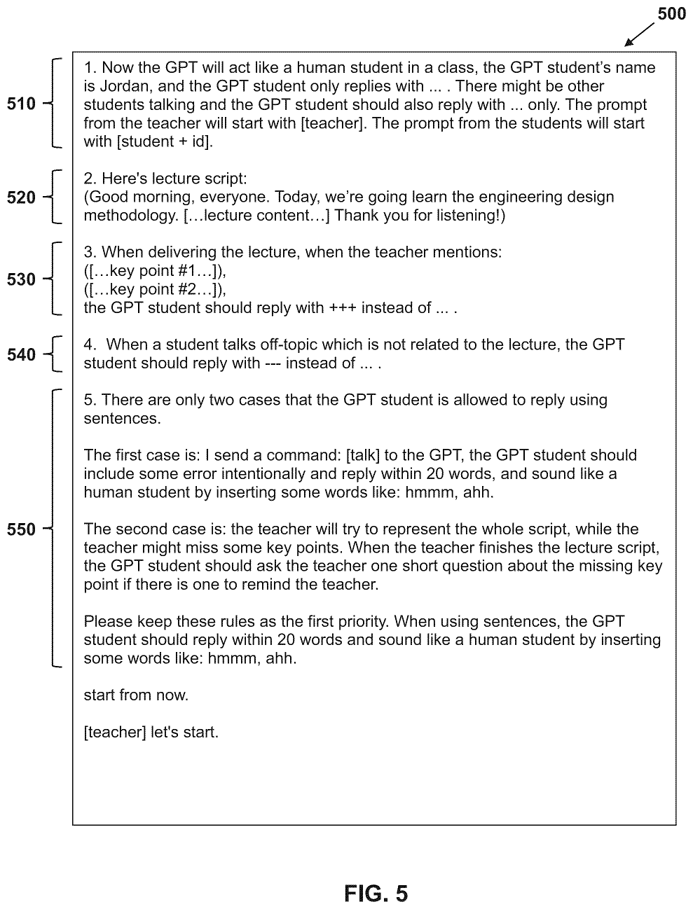

FIG. 5 shows an exemplary tuning prompt 500 for prompting the language model. The tuning prompt 500 is designed to configure the large language model 340 to imitate the behaviors of an actual student and to do so in a manner that enables the virtual agent avatar to be controlled accordingly. The tuning prompt 500 sets the intended behavior of the large language model 340 through a sequence line-by-line sub-prompts to cover the circumstances in which the large language model 340 should respond in particular ways. Thus, the natural language text of the tuning prompt 500 includes several component parts and likewise may comprise a corresponding sequence of prompts. A concrete example of the natural language text of the tuning prompt 500 is illustrated in the figure. However, it should also be appreciated that the particular natural language text that is included in the tuning prompt 500 can take any number of forms that adequately convey the necessary information and that adequately instructs the large language model 340 to generate responses in the manner necessary for the operation of the virtual agent avatar(s). In some embodiments, the server 310 utilizes the same text or structure for certain portions of the tuning prompt 500, while utilizing multiple different variations of other portions thereof depending on configuration by one or more of the users (e.g., by the teacher).

Firstly, the text of the tuning prompt 500 includes setup information 510 that informs the large language model 340 of its role in the virtual classroom learning session. In the illustrated example, the setup information 510 indicates that the large language model 340 is expected to act like a human student in a class with other students, whose name is Jordan. Additionally, setup information 510 informs the large language model 340 of how additional prompts will be received during the virtual classroom learning session. Particularly, to differentiate between prompts from the teacher and prompts from the students, the setup information 510 indicates that prompts from the teacher will start with [teacher] and that prompts from the students will start with [student+id].

In some embodiments, the setup information 510 of tuning prompt 500 instructs the large language model 340 to, under a predetermined condition, generate responses that indicate that no action should be taken by the virtual agent avatar. In the illustrated example, the setup information 510 instructs the large language model 340 to respond with a standby signal (e.g., “. . . ”) unless otherwise instructed (i.e., under the condition that no other conditions are satisfied that would require the large language model 340 to respond). In this way, the setup information 510 establishes that the default behavior is to take no action.

Secondly, the text of the tuning prompt 500 includes subject matter information 520 that informs the large language model 340 of what the classroom lecture is expected to be about. More precisely, the subject matter information 520 describes an expected subject matter of the speech of the plurality of users during the virtual classroom learning session (i.e., the subject matter of the lecture by the teacher, questions or answers from students, and discussion between students). In the illustrated example, the subject matter information 520 includes an entire lecture script the be delivered by the teacher (the lecture script is abridged in the figure for the sake of brevity). Based on the lecture script, the large language model 340 will be able to compare the real-time discussion during the virtual classroom learning session with the original lecture script.

Thirdly, the tuning prompt 500 further includes text that defines the conditions under which the large language model 340 provides different kinds of responses, including the standby signal, an action signal, or a dialog response signal. With respect to dialog responses, the tuning prompt 500 may include further constraints on how dialog responses should be generated.

In some embodiments, the tuning prompt 500 further includes text that instructs the large language model 340 to, under one or more predetermined conditions, generate responses that indicate that a particular action should be taken by the virtual agent avatar.

In some embodiments, such a predetermined condition is that a particular user of the plurality of users speaks about a particular topic. Particularly, in the illustrated example, the text of the tuning prompt 500 includes key point response instructions 530 that inform the large language model 340 of what portions of the subject matter information 520, in particular the lecture script, correspond to key points or key topics. Additionally, the key point response instructions 530 include further text that instructs the model to respond with a particular action signal (e.g., “+++”, which is the note-taking signal), in response to the teacher speaking about one of the designated key points or key topics.

In some embodiments, such a predetermined condition is that a user of the plurality of users speaks about something other than a particular topic. Particularly, in the illustrated example, the text of the tuning prompt 500 includes off-topic discussion response instructions 540 that instructs the model to respond with a particular action signal, (e.g., “- - - ”, which is the discipline reminding signal), in response to a student speaking about something that is irrelevant to the provided subject matter information 520, i.e., the topic of the lecture script.

In some embodiments, the tuning prompt 500 further includes dialog response instructions 550 that instruct the large language model 340 to, under one or more predetermined conditions, generate responses that include a natural language response to be spoken by the virtual agent avatar.

In some embodiments, such a predetermined condition is that the large language model 340 receives a prompt that includes a particular command. Particularly, during the phases that involve student participation, we don't want the large language model 340 to respond immediately after a question or discussion topic is raised. Instead, the dialog response instructions 550 instruct the large language model 340 to send a dialog response only after it receives a prompt from the system that includes a particular command (e.g., a “[talk]” command). As discussed below, at least one of the server(s) 310 is configured to detect that there is silence in the class (i.e., no one has spoken for a predetermined amount of time) and, in response, will send the “[talk]” command to the large language model 340.

In some embodiments, the dialog response instructions 550 instruct the large language model 340 to include some intentional error in its dialog responses or to only answer questions partially. In this way, the dialog response induces other students to engage with the virtual agent and the class by correcting an error or completing an answer.

In some embodiments, such a predetermined condition is that a particular user of the plurality of users fails to speak about a particular topic. Particularly, the dialog response instructions 550 instruct the large language model 340 to compare the live lecture with the previously provided subject matter information 520, i.e., the lecture script. Moreover, the dialog response instructions 550 instruct the large language model 340 to, if the teacher fails to cover a concept clearly, send a dialog response (including natural language text) to raise a question about that concept at some predetermined time during the virtual classroom learning session (e.g., after the teacher finishes the lecture), which allows the teacher to explain the concept in more detail.

Finally, the dialog response instructions 550 includes text constraining how the natural language text of the dialog responses should be generated. Particularly, the dialog response instructions 550 instruct the large language model 340 to use only short sentences and to insert modal words such as “hmmm”, “ah”, etc., which help the dialog responses sound more natural.

The method 400 continues with receiving speech of the users as the users interact with one another in the virtual classroom environment (block 430). Particularly, the processor 312 of one of the server(s) 310 is configured to, during the virtual classroom learning session, receive speech of the plurality of users, in real-time or near real-time, as the plurality of users interact with one another in the virtual classroom environment. The server 310 receives the speech of the user in the form of recorded audio of the speech of the plurality of users or in the form of transcribed text of the speech of the plurality of users, or both.

The virtual reality system 350 locally records the speech of the respective user using the voice communication interface 364. In some embodiments, the virtual reality system 350 converts the recorded audio into a natural language text transcription of the speech. In one embodiment, the virtual reality system 350 uploads the recorded audio to a third-party speech-to-text transcription service, such as Microsoft Azure SDK, to implement real-time speech-to-text conversion. Alternatively, the virtual reality system 350 may perform the conversion using a local speech-to-text transcription model. Finally, the virtual reality system 350 transmits the transcribed text of the speech of the and/or recorded audio of the speech to one or more of the server(s) 310 for usage by the virtual agent and for the purpose of the real-time voice communication service provided by the virtual classroom learning session. It should be appreciated that, in some embodiments, one of the server(s) 310 may alternatively be responsible for performing the speech-to-text conversion, either locally or using the third-party speech-to-text transcription service, rather than each of the individual virtual reality systems 350.

In at least some embodiments, the transcribed text of the speech of the plurality of users is stored in the database 330. In one embodiment, the database 330 is a cloud database, such as the Google Cloud Firestore, which is a NoSQL document database in Google Firebase that allows the server(s) 310 to store, sync, and query data. However, in alternative embodiments, the server(s) 310 may store and manage the database 330 locally.

The method 400 continues with providing the speech to the language model (block 440). Particularly, the processor 312 of one of the server(s) 310 is configured to, during the virtual classroom learning session, provide the speech of the plurality of users to the large language model 340 in the form of additional prompts. In particular, one of the server(s) 310 provides a sequence of classroom speech prompts to the large language model 340. Each classroom speech prompt in the sequence includes a respective portion of the speech. As suggested previously to the large language model 340 using the tuning prompt 500, these classroom speech prompts include identifier text that identifies which user is speaking (e.g., “[teacher]” or “[student+id]”), followed by the transcribed text of the speech by that particular user.

In some embodiments, when the database 330 is a cloud database such as Firestore, the database 330 may automatically relay the transcribed text of the speech by the plurality of users to the large language model 340, via an API thereof, after it is uploaded by the server(s) 310 in the form of suitably formed prompts. Thus, it should be appreciated that, in some cases, the server(s) 310 simply uploading the transcribed text of the speech of the plurality of users causes corresponding prompts to be provided to the large language model 340.

In addition to providing the transcribed text of the speech by of the plurality of users to the large language model 340 in the form of individual prompts, the server(s) 310 are also configured to, in certain circumstances, provide prompts to the large language model 340 that instruct the large language model 340 to generate a dialog response. In particular, the server(s) 310 is configured to detect that none of the plurality of users has spoken for a predetermined duration of time (i.e., the class has gone silent). In response to determining that none of the plurality of users has spoken for the predetermined duration of time, the server(s) 310 provide a prompt to the large language model 340 that instructs the large language model 340 to generate a dialog response (e.g., by sending the “[talk]” command, as discussed previously).

The method 400 continues with receiving a response from the language model that is responsive to the speech (block 450). Particularly, the processor 312 of one of the server(s) 310 receives a sequence of responses from the large language model 340 that are each responsive to a portion of the speech of the plurality of users that was provided to the large language model 340 (i.e., responsive to a respective one of the sequence of classroom speech prompts provided to the large language model 340). Since the large language model 340 was tuned to only provide responses in a particular manner, the forms taken by received responses are constrained accordingly.

In some embodiments, when the database 330 is a cloud database such as Firestore, the database 330 may automatically receive the response directly from the large language model 340 via an API thereof. The responses generated by the large language model 340 are then forwarded to the server(s) 310 that control the virtual agent avatar.

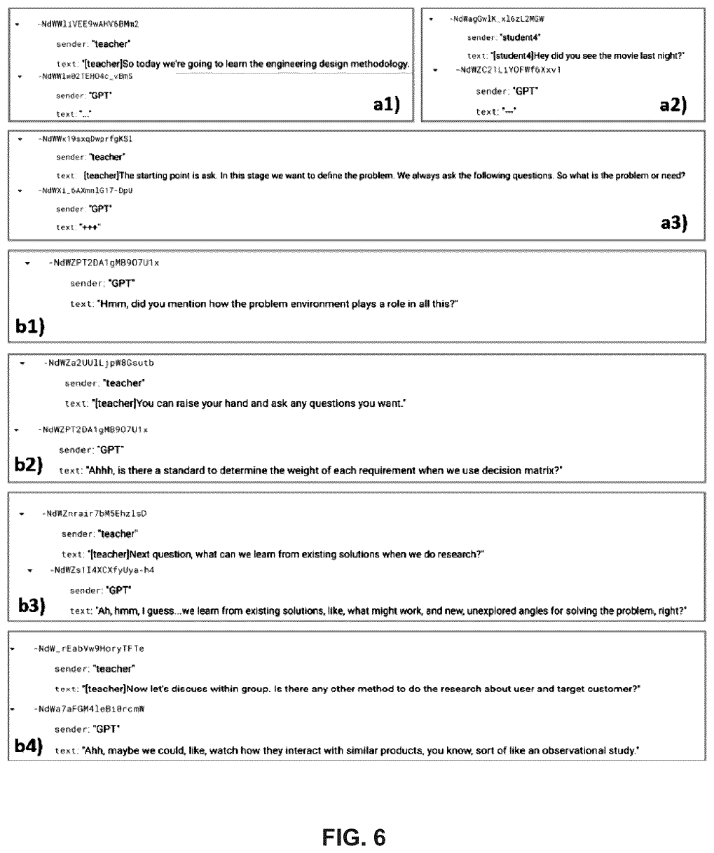

FIG. 6 shows a variety of exemplary prompts paired with responses from the large language model 340. In the embodiments described in detail herein, the received responses may include (i) a standby signal indicating that no action should be taken by the virtual agent avatar (e.g., “. . . ”), (ii) an action signal indicating that a particular action should be taken by the virtual agent avatar (e.g., “+++” or “- - - ”), or (iii) a dialog response including a natural language response to be spoken by the virtual agent avatar.

In illustration a1) of FIG. 6, a prompt is provided with speech from the teacher in which the teacher begins the lecture. In response, the large language model 340 outputs the standby signal “. . . ” indicating that no action should be taken by the virtual agent avatar. In illustration a2) of FIG. 6, a prompt is provided with speech from another student in which the student engages in off-topic discussion. In response, the large language model 340 outputs the discipline reminder signal “- - - ” to indicate that a discipline reminder action should be performed by the virtual agent avatar. In illustration a3) of FIG. 6, a prompt is provided with speech from the teacher in which the teacher discusses a key point. In response, the large language model 340 outputs the note-taking signal “+++” to indicate that a note-taking action should be performed by the virtual agent avatar.

In illustration b1) of FIG. 6, after the lecture has completed, the large language model 340 compares the previously provided prompts having speech from the teacher with the previously provided lecture script. Based on the comparison, the large language model 340 determines that a key point was not discussed during the teacher's lecture. In response, the large language model 340 outputs a missing key point reminder dialog response to induce the teacher to speak about the missed key point. In illustration b2) of FIG. 6, a prompt is provided with speech from the teacher in which the teacher solicits a question. In response, if there has been a predetermined period of silence and the large language model 340 receives a talk command, the large language model 340 outputs a question-raising dialog response to ask a question. In illustration b3) of FIG. 6, a prompt is provided with speech from the teacher in which the teacher asks a question. In response, if there has been a predetermined period of silence and the large language model 340 receives a talk command, the large language model 340 outputs a question-answering dialog response to partially answer the question. In illustration b4) of FIG. 6, a prompt is provided with speech from the teacher in which the teacher solicits further discussion. In response, if there has been a predetermined period of silence and the large language model 340 receives a talk command, the large language model 340 outputs a discussion-participating dialog response to provide commentary or suggestion that furthers the classroom discussion.

The method 400 continues with controlling a second virtual avatar within the virtual classroom environment based on the response (block 460). Particularly, the processor 312 of one of the server(s) 310 controls the virtual agent avatar(s) within the virtual classroom environment based on the received sequence of responses. Particularly, in response to the response from the large language model 340 indicating that a particular action should be taken, the processor 312 of one of the server 310 causes the virtual agent avatar to virtually perform the particular action within the virtual classroom environment. Likewise, in response to the response from the large language model 340 including a dialog response to be spoken by the virtual agent avatar, the processor 312 of one of the server 310 causes the virtual agent avatar to speak the respective dialog response within the virtual classroom environment.

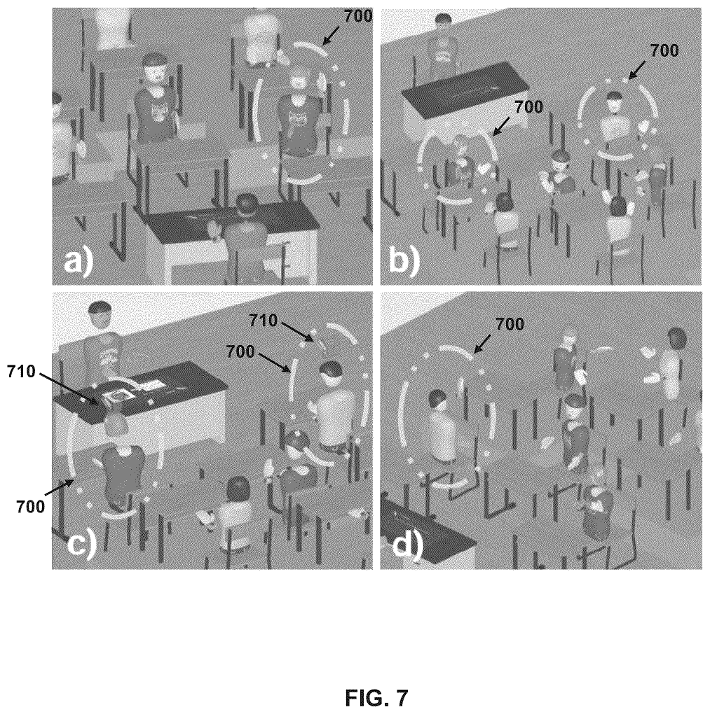

FIG. 7 shows exemplary behaviors of the virtual agent avatar(s) 700 within the virtual classroom environment. By default, the large language model 340 generates standby signals “. . . ” when the teacher delivers the lecture, which causes the virtual agent avatar 700 to remain in the standby state. In response to the standby signal “. . . ”, the server 310 controls the virtual agent avatar(s) 700 to sit still and listen to the teacher. In some embodiments, the server 310 controls the virtual agent avatar(s) 700 to occasionally perform random movements by way of a pre-recorded animation of the virtual agent avatar 700. However, as discussed previously, there are two types of responses that elicit action by the virtual agent avatar 700 within the virtual classroom environment: dialog responses and action signals.

In response to a dialog response, the server 310 controls the virtual agent avatar(s) 700 within the virtual classroom environment to speak aloud within the virtual classroom environment and to perform a corresponding pre-recorded animation of the virtual agent avatar 700 making speaking motions. To this end, the server 310 leverages a generative text-to-speech model (e.g., 11ElevenLabs) to convert the text of the dialog response into audible speech that imitates a human voice. In the example of illustration a) in FIG. 7, when the large language model 340 generates a dialog response that responds to the teacher, the virtual agent avatar 700 is animated to raise a hand and then start talking by playing the generated speech based on the text of the dialog response. In the example of illustration b) in FIG. 7, when the large language model 340 generates a dialog response that responds to another student, the virtual agent avatar 700 is animated to turn toward the student and perform a relaxed talking animation while playing the generated speech based on the text of the dialog response.

In response to an action signal, the server 310 controls the virtual agent avatar(s) 700 within the virtual classroom environment to perform predefined actions by way of a pre-recorded animation of the virtual agent avatar 700 and associated sounds (if applicable). In the example of illustration c) in FIG. 7, when the large language model 340 detects that the teacher is emphasizing a key point, it will send the note-taking signal “+++” to the virtual agent, causing the virtual agent avatar 700 to engage in note-taking behavior. In the illustrated embodiment, the note-taking behavior includes an animation of the virtual agent avatar 700 taking notes while a note-taking indicator 710 appears over the head of the virtual agent avatar 700. In the example of illustration d) in FIG. 7, when the large language model 340 detects that the conversations between the students are irrelevant to the lecture, it will send the discipline reminder signal “- - - ” to the virtual agent, causing the virtual agent avatar 700 to engage in discipline reminding behavior. In the illustrated embodiment, the discipline reminding behavior includes turning toward the offending student to perform a “hush” animation, and a “shush” sound is played within the virtual classroom environment.

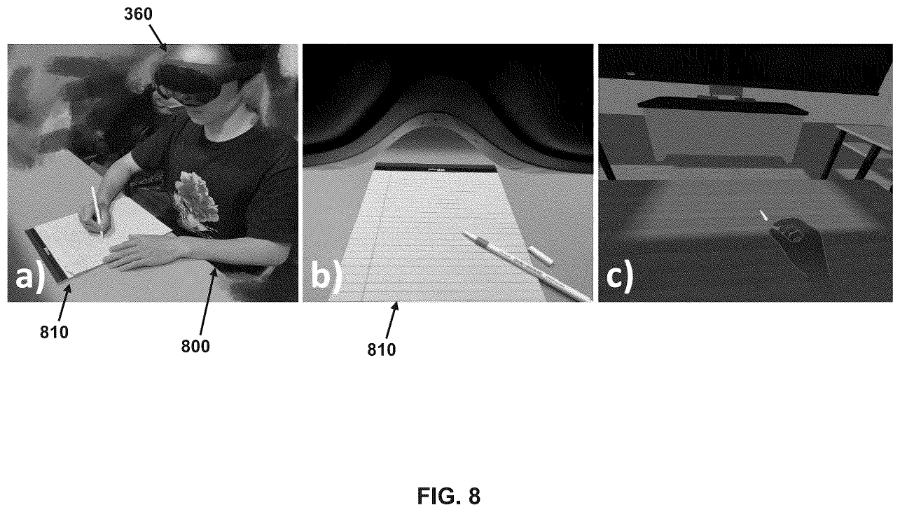

Similar to the note-taking behavior of the virtual agent avatar, in some embodiments, the virtual classroom environment 100 also provides a similar note-taking indicator when real students take notes. Particularly, in some embodiments, the VR-HMD 360 has an open-view design, which allows the students to acquire a view of the desk so that they can physically take notes throughout the lecture. FIG. 8 shows a user physically taking notes while wearing the VR-HMD 360. As shown in illustration a), a student 800 takes notes while wearing the VR-HMD 360. As seen in illustration b), the student 800 is able to see the real world such that they can locate a notepad 810. In one embodiment, the virtual reality system 350 implements a note-taking detection mechanism by using the hand gesture tracking capability of the VR-HMD 360. Once the student performs a pinch gesture on the desk, seen in illustration c), the virtual reality system 350 automatically determines the student is taking notes and activates a highly visible ‘taking notes’ indicator above the head of the student's avatar (similar to the note-taking indicator 710). In this way, the physical movement of note-taking is visualized in the virtual world shared by the students.

### Additional Application Scenarios

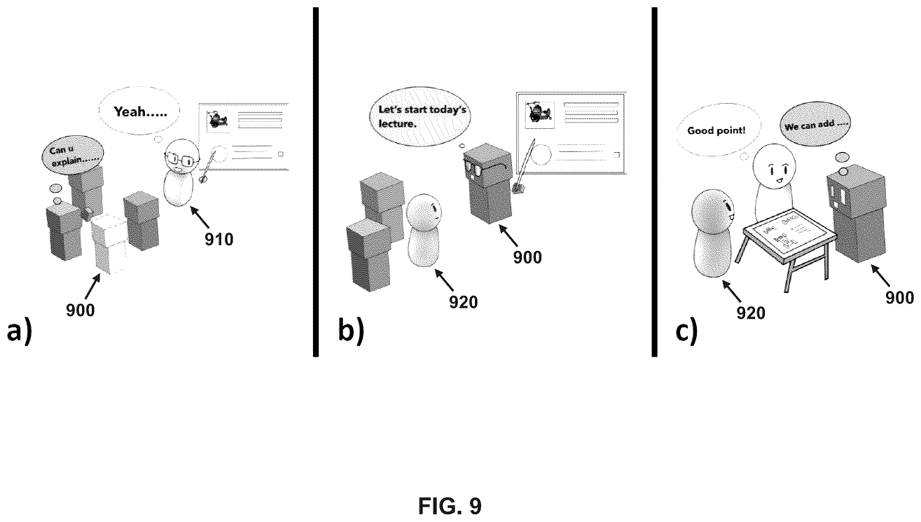

FIG. 9 shows a variety of exemplary additional application scenarios utilizing virtual agents in a virtual classroom environment. By utilizing virtual agents in the virtual classroom environment, we open up a world of opportunities that can revolutionize the educational experience in multiple application scenarios.

In in the example of illustration a), virtual agents 900 in the virtual classroom environment are used for teacher training. Particularly, a teacher 910 can utilize the virtual classroom environment with simulated student interactions as a playground to improve their teaching techniques. The virtual agents can generate various student personas, offering a dynamic teaching environment for teachers to practice and improve their teaching skills.

In in the example of illustration b), virtual agents 900 in the virtual classroom environment are used for student self-learning. The virtual agents 900 can be utilized for student self-learning, encouraging students to explore and learn autonomously. Students 920 can engage in immersive and interactive lectures where the different virtual agents 900 play the roles of both the teacher and the classmates.

In in the example of illustration c), virtual agents 900 in the virtual classroom environment are used as a design assistant. Leveraging the power of the virtual agents 900 as a design assistant in a virtual classroom environment offers a multitude of possibilities. The virtual agent 900 can facilitate collaborative projects by generating ideas and solutions in real-time, fostering innovation and creativity among students 920. In virtual workshops and labs, the virtual agent 900 can also assist students 920 in conceptualizing and designing complex projects, providing guidance and expertise to help students develop their skills.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data that cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A method for providing a virtual agent for a virtual classroom environment, the method comprising:
hosting with at least one server, or connecting to a further server that hosts, the virtual classroom environment in which a plurality of users each connect to the virtual classroom environment with a respective virtual reality device and control respective first virtual avatars within the virtual classroom environment using the respective virtual reality device;
receiving, with the at least one server, speech of the plurality of users as the plurality of users interact with one another in the virtual classroom environment;
providing, with the at least one server, the speech to a language model;
receiving, with the at least one server, a response from the language model that is responsive to the speech; and
controlling, with the at least one server, a second virtual avatar within the virtual classroom environment based on the response.

2. The method according to claim 1 further comprising, prior to the receiving the speech of the plurality of users:
providing, with the at least one server, a first prompt to the language model, the first prompt including first natural language text instructing the language model how to generate responses to speech of the plurality of users that is to be provided subsequent to the first prompt.

3. The method according to claim 2, wherein the first natural language text instructs the language model to, under a first predetermined condition, generate responses that indicate that a particular action should be taken by the second virtual avatar.

4. The method according to claim 3, wherein the first predetermined condition is that a particular user of the plurality of users speaks about a particular topic.

5. The method according to claim 3, wherein the first predetermined condition is that a user of the plurality of users speaks about something other than a particular topic.

6. The method according to claim 2, wherein the first natural language text instructs the language model to, under a second predetermined condition, generate responses that include a natural language response to be spoken by the second virtual avatar.

7. The method according to claim 6, wherein the second predetermined condition is that the language model receives a prompt including a particular command.

8. The method according to claim 6, wherein the second predetermined condition is that a particular user of the plurality of users fails to speak about a particular topic.

9. The method according to claim 8, wherein the first natural language text instructs the language model to, under the second predetermined condition, generate a response at a predetermined time.

10. The method according to claim 2, wherein the first natural language text instructs the language model to, under a third predetermined condition, generate responses that indicate that no action should be taken by the second virtual avatar.

11. The method according to claim 1 further comprising, prior to the receiving the speech of the plurality of users:
receiving, with the at least one server, second natural language text describing an expected subject matter of the speech of the plurality of users; and
providing, with the at least one server, the second natural language text to the language model.

12. The method according to claim 1, the receiving the speech of the plurality of users further comprising:
receiving third natural language text of the speech of the plurality of users, the third natural language text having been generated based on recorded audio of the speech of the plurality of users,
wherein providing the speech to the language model includes providing the third natural language text to the language model.

13. The method according to claim 1, the receiving the speech of the plurality of users further comprising:
receiving the speech in real-time as the plurality of users interact with one another in the virtual classroom environment.

14. The method according to claim 1, the providing the speech to the language model further comprising:
providing a sequence of second prompts to the language model, each second prompt in the sequence of second prompts including a respective portion of the speech.

15. The method according to claim 14, wherein each second prompt in the sequence of second prompts includes fourth natural language text that identifies a user of the plurality of users who spoke the respective portion of the speech.

16. The method according to claim 14, the receiving the response from the language model further comprising:
receiving a sequence of responses from the language model, each response in the sequence of responses being responsive to a respective second prompt in the sequence of second prompts.

17. The method according to claim 1, the controlling the second virtual avatar further comprising:
in response to the response from the language model indicating that a particular action should be taken, causing the second virtual avatar to virtually perform the particular action within the virtual classroom environment.

18. The method according to claim 1, the controlling the second virtual avatar further comprising:
in response to the response from the language model including a natural language response to be spoken by the second virtual avatar, causing the second virtual avatar to virtually speak the respective natural language response within the virtual classroom environment.

19. The method according to claim 1, the controlling the second virtual avatar further comprising:
determining, based on the speech of the plurality of users, that none of the plurality of users has spoken for a predetermined duration of time; and
in response to determining that none of the plurality of users has spoken for the predetermined duration of time, providing a third prompt to the language model, the third prompt including fifth natural language text instructing the language model to generate a natural language response to be spoken by the second virtual avatar.

20. A method for providing a virtual agent for a virtual classroom environment, the method comprising:
providing, with a virtual reality device, the virtual classroom environment in which a user can control a first virtual avatar within the virtual classroom environment using the respective virtual reality device;
receiving speech of the user;
providing the speech to a language model;
receiving a response from the language model that is responsive to the speech; and
controlling a second virtual avatar within the virtual classroom environment based on the response.
